(19) United States
(12) Patent Application Publication
(10) Pub. No.: US 2010/0051412 A1
(43) Pub. Date: Mar. 4, 2010

(54) Roller For Attaching to an Axle of a Conveying or Storage Device to Aid in the Transport of an Object

(75) Inventor: Ernest J. DeLanghe, Burnsville, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: CALIBER PRODUCTS, INC., Burnsville, MN (US)

(21) Appl. No.: 12/550,712

(22) Filed: Aug. 31, 2009

Related U.S. Application Data
(60) Provisional application No. 61/092,860, filed on Aug. 29, 2008.

(51) Int. Cl. B65G 13/00

(52) U.S. Cl. 193/37

(57) ABSTRACT

A roller for positioning on a member of a conveying or transportation device where the member acts as a stationary axle for the roller includes an outer shell typically constructed from a compressible thermoplastic, rubber or polymeric material and a hollow inner core typically constructed from a rigid thermoplastic or polymeric material. The roller includes a through bore defined by axle engaging ribs where the ribs engage a circumference of the axle substantially perpendicular to an axis of the member such that the roller is rotatable about an axis of the axle. The outer shell is typically molded over the inner rigid shell where the outer shell is of a selected thickness that does not compress over time due to the weight of the boat or watercraft.

### CROSS REFERENCE TO RELATED APPLICATION(S)

The present application claims the benefit of U.S. Provisional Patent Application Ser. No. 61/092,860 which was filed on Aug. 29, 2009, the contents of which are incorporated by reference in its entirety.

### FIELD OF THE INVENTION

The present invention relates to a roller for attaching to an axle of a conveying or storage device to aid in the transport of an object. More particularly, the present invention relates to a construction of a roller that utilizes a rigid and hollow inner core with an outer flexible layer secured to the outer surface of the rigid and hollow inner core.

### BACKGROUND OF THE INVENTION

There are numerous rollers that are attached to conveying and storage devices that aid in the transportation of an object. A non-exhaustive list of conveying and transportation devices include trailers, ports, rail systems and lifts some of which are specially designed for watercraft.

With respect to watercraft, these devices are typically utilized to move and store boats. The devices typically utilize rollers rotatably positioned about a rigid members of the device where the rollers aid in moving and positioning a boat on the conveying or storage device. As the hull of the watercraft contacts the roller, the roller rotates on the member, which acts as a stationary axle. As the roller rotates, the boater can more easily move the watercraft onto, and off of, the trailer, port, rail system or lift.

A typical construction of a watercraft roller includes a solid polymeric material that includes a throughbore along an axial length of the roller. A metal bushing is positioned inside the roller along the length of the roller to add strength to the polymeric material.

However, a solid polymeric roller with a metal bushing has a tendency of forming flat spots on the roller due to the compression of the polymeric material caused by the weight of the watercraft on the roller over a period of time. Once the roller develops a flat spot, the watercraft does not travel easily over the surface of the roller, which causes difficulties in moving the watercraft onto or off of the conveying or lifting device.

Further, since the contact area between many rollers and the axle runs the entire length of the roller, the friction between the roller and the axle can be substantial and resist rotation of the roller about the axle. With an increase in friction between the bushing and the axle, the roller has less of a tendency to rotate freely about the axis of the axle.

### SUMMARY OF THE INVENTION

The present invention includes a roller for positioning on a member of a conveying or transportation device where the member acts as a stationary axle for the roller. The roller includes an outer shell typically constructed from a compressible thermoplastic, rubber or polymeric material and a hollow inner core typically constructed from a rigid thermoplastic or polymeric material. The roller includes a throughbore defined by axle engaging ribs where the ribs engage a circumference of the axle substantially perpendicular to an axis of the member such that the roller is rotatable about an axis of the axle. The outer shell is typically molded over the inner rigid shell where the outer shell is of a selected thickness that does not compress over time due to the weight of the boat or watercraft.

### BRIEF DESCRIPTION OF THE DRAWINGS

FIG. 1 is a perspective view of an inner core of a roller.

FIG. 2 is a cross-sectional view of a shell the roller.

FIG. 3 is another cross-sectional view of the roller including internal ribs.

FIG. 4 is a sectional view of two halves of a roller attached along a rib defining a through bore.

FIG. 5 is a perspective view of one half of a roller having a smooth outer surface.

FIG. 6 is a top view of one half of a multi-piece roller.

### DETAILED DESCRIPTION OF ILLUSTRATIVE EMBODIMENTS

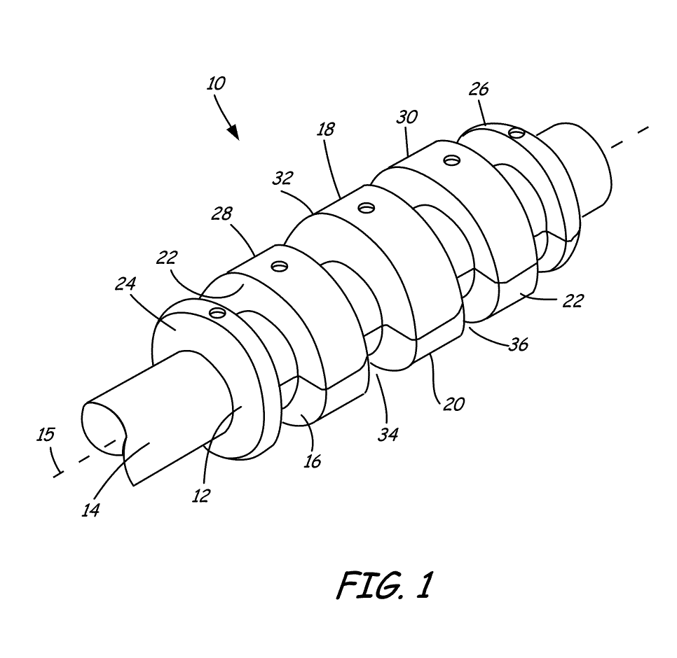

A roller for attaching to a member of a conveying or lifting device such as a watercraft trailer, port, rail system or lift is generally depicted at 10 in FIG. 1. While the application references devices related to the transport and lifting of watercraft, the roller 10 can also be utilized with other devices that are not related to the transport and/or lifting of watercraft.

The roller 10 includes a through bore 12 that allows the roller to be positioned about a member 14 of a conveying or lifting device. The member 14 provides a stationary axle such that the roller 10 can rotate about an axis 15 of the member 14.

The roller 10 typically includes a rigid polymeric core 16 that includes a left half 18 and a right half 20 that are secured together. The rigid polymeric core is typically constructed through a molding process utilizing a glass filled polymer such as high density polyethylene (HDPE). However, other polymeric materials that are moldable into a rigid form are also contemplated.

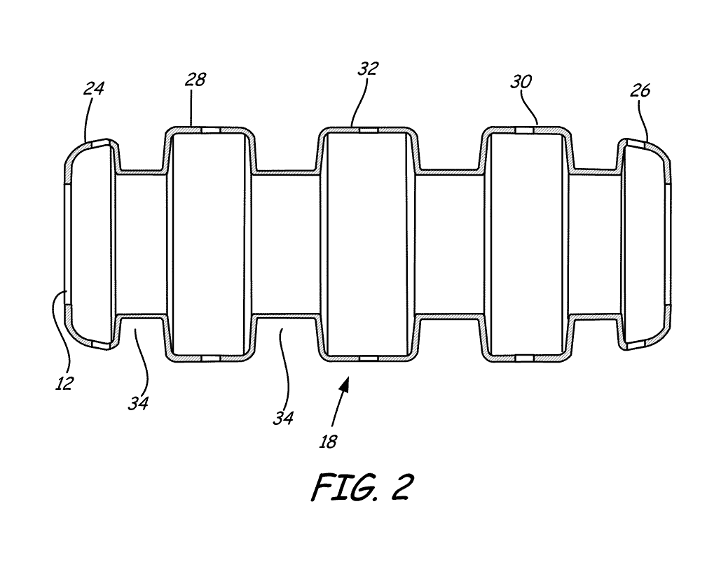

Referring to FIGS. 1 and 2, the left and right halves 18 and 20 are joined together to form a substantially continuous outer surface 22. The outer surface typically includes left and right outer rib portions 24 and 26, right middle portions 28 and 30 and a center rib 22. The outer surface of the ribs 24, 26, 28, 30 and 32 form an interrupted arcuate surface having a common radius such that a boat or other watercraft can engage the outer surface 22 without damaging the hull of the boat or other watercraft.

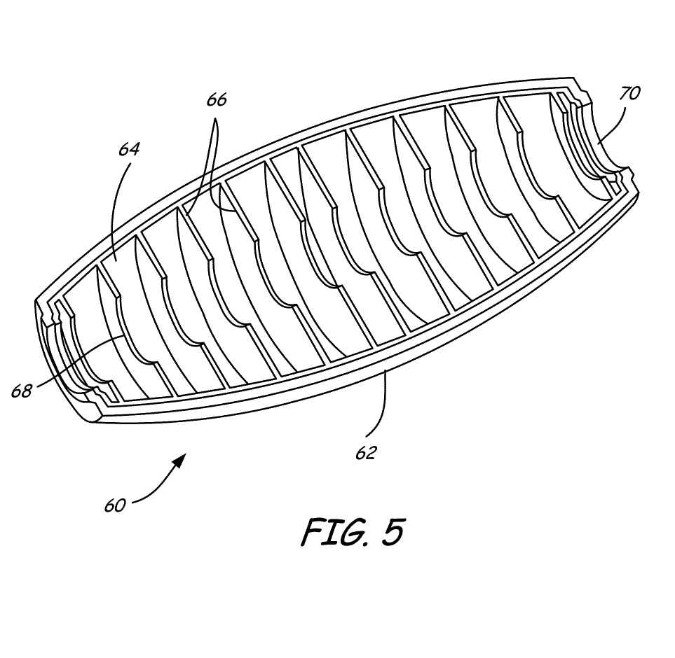

The ribs 24, 26, 28, 30 and 32 are separated by a plurality of channels 34, which decrease the amount of surface area that the watercraft contacts on the roller 10. Decreasing the contact surface area of the roller 10 with the watercraft increases the amount of pressure per square inch on the roller 10 caused by the weight of the watercraft which in turn prevents slippage between the roller 10 and the watercraft such that a roller 10 smoothly conveys the watercraft. However, a smooth and uninterrupted outer surface 22 of the roller 10 is also contemplated as best illustrated in FIG. 5.

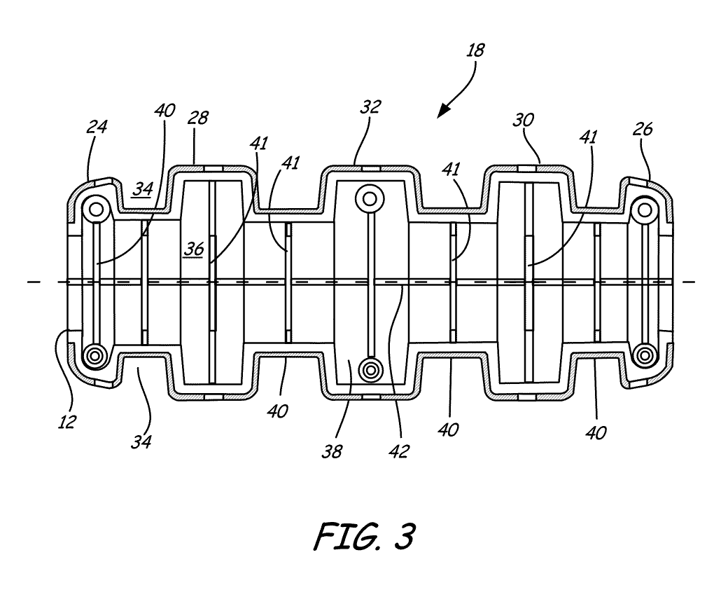

Referring to FIG. 3, the rigid polymeric core 16 includes a hollow interior cavity 36 which is reinforced by a plurality of ribs 40 that extend from an inner surface 38 such that when the roller 10 is mounted to the member, the ribs 40 are substantially perpendicular to the axis of the member. Each rib includes an arcuate bearing surface 41 that conforms to a perimeter of the member. Utilizing ribs 40 reduces the contact area of the roller 10 on the member and therefore reduces the amount of friction between the roller 10 and the member such that the roller 10 more freely rotates about the member as compared to a roller with a solid bushing.

The left and right halves 18 and 20 has a similar construction, such that the left and right halves 18 and 20 can be made from the same mold where one half is rotated 180° from the other half to form mating surfaces. The halves 18 and 20 include a longitudinal rib 42 extending from one end to the other end. The longitudinal rib 42 is located at the apex of the arcuate surface and extends toward the member when the roller is positioned thereon. The rib 42 intersects the ribs 40 and is aligned with the axis of the member wherein the rib 42 provides strength and rigidity to the roller halves while reducing the amount of materials needed for a solid roller.

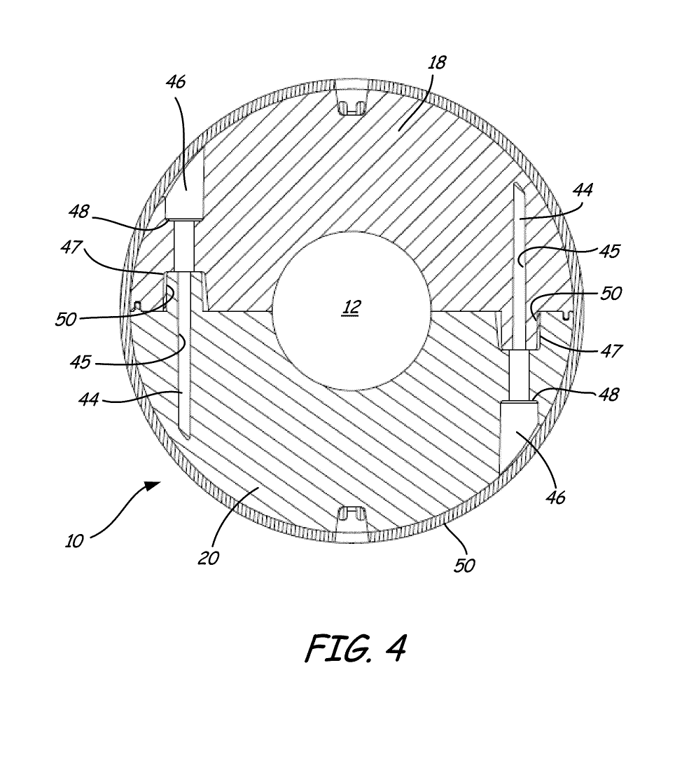

Referring to FIG. 4, the halves 18 and 20 mate such that a receptacle 47 of one half aligns with a protrusion 50 in the other half. With the alignment of the cavities 44 with the protrusions 50, a screw can be positioned into an opening 46 such and rotated such that the screw frictionally engages a wall 45 of the cavity 44 to retain the two halves 18 and 20 together. While a screw is contemplated, other attachment mechanisms are also contemplated including, but not limited to, a snap fit and an adhesive bond.

An outer layer 50 is molded onto the joined halves 18 and 20 where the outer layer 50 is typically a compressible and moldable material such as a compressible thermoplastic, rubber or polymeric material. Typical materials sutilized to form the outer layer is SEBS Poly(Styrene-Ethylene-Butadiene-Styrene) Elastomer, TPU Thermoplastic Polyurethene, TPO Thermoplastic Polyolefin, TPE Thermoplastic Elastomer or a mixture thereof. However other compressible and moldable materials are also contemplated for the outer layer.

The outer layer 50 is typically about 0.1 inches thick. However the thickness of the outer layer can be in the range of about 0.03 inches and about 0.3 inches. An outer layer of between about 0.03 inches thick and about 0.3 inches thick does not compress when under sustained loads and therefore increases the effectiveness of the roller 10.

Therefore, the present invention provides for a low-cost roller which does not flatten with use over time due to the weight of the watercraft because of the thickness of the outer layer 50. Further, because only the bearing surfaces 41 engage the member or axle of the boat trailer, the amount of friction between the internal of the roller and the watercraft trailer, port, rail system, lift, etc. are reduced.

Referring to FIG. 5, a half of roller 60 is illustrated where the external surface has a substantially smooth surface. Another half would connect to the half of the roller 60 to form the inner core of the roller. The roller would then have an outer layer of compressible material coated onto the roller as described with respect to the roller 10. The half 60 does not include any valleys but has a similar construction to of the roller 10. The roller half 60 includes a smooth outer surface 62 as well as a plurality of ribs 66 that extend around the inner perimeter 64 of the roller half 60. When a roller constructed of two halves 60 is attached to an axle, the ribs 66 are substantially perpendicular to the axis of rotation about the axle. The ribs 66 include arcuate bearing surfaces 68 which form a throughbore 70 through which the axle is positioned.

Similar to the construction of the roller 10, the roller constructed from the halves 60 is constructed to reduce the amount of costs due to the raw materials and molding time because the roller is constructed from a shell that includes ribs within a hollow cavity instead of having a solid polymeric roller. Further, due to the structure of the outer layer, there is less of a tendency of the roller to create flat surfaces due to the weight of the watercraft over time. Finally, the bearing surfaces 68 are provide substantially less contact area than a solid surface such as a bushing contacting the axle. As such, the amount of friction is reduced utilizing the roller.

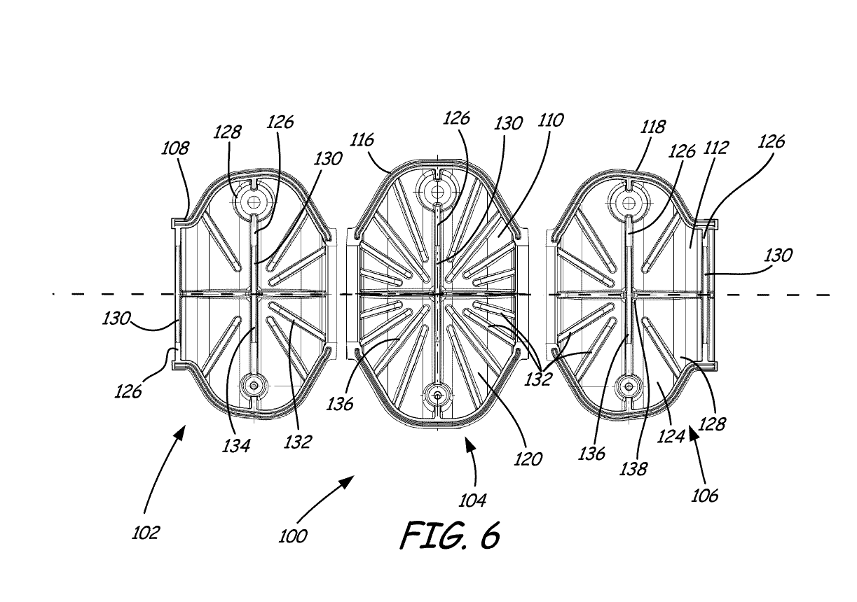

A roller 100 can also be constructed utilizing multiple independent segments 102, 104 and 106 as illustrated in FIG. 6. The roller segments 102, 104 and 106 together form a roller having a structure similar to the roller 10. However, each of the roller segments 102, 104 and 106 rotate independent of each other such that depending upon how the hull of a watercraft contacts the roller segments 102, 104 and 106 only the roller segments in contact with the hull will rotate, thereby increasing the ease with which the watercraft is conveyed on the conveying or lifting device.

The segment 106 is the mirror image of the segment 102. However, the outer segments 102 and 106 do not have to be mirror images. Also one or more segments 102, 104 and 106 could be utilized as the entire roller depending upon the desired application.

Each segment 102, 104 and 106 include a rigid inner core 108, 110 and 112, that has an outer layer 114, 116 and 118 molded to the inner cores 108, 110 and 112, respectively. The construction of the outer layers 114, 116 and 118 are similar to that of the construction of the outer layer 50 on the roller 10.

Each segment 102, 114 and 116 includes a hollow cavity 120, 122 an 124 that includes a plurality of ribs 126 that extend from an inner surface 128 such that when the roller 10 is mounted to the member, the ribs 128 are substantially perpendicular to the axis of the member. Each rib 128 includes an arcuate bearing surface 130 that conforms to a perimeter of the member. Utilizing ribs 126 reduces the contact area of the roller 100 on the member and therefore reduces the amount of friction between the roller 100 and the member such that the roller 100 more freely rotates about the member as compared to a roller with a solid bushing.

The segments 102, 104 and 106 include a plurality of reinforcing ribs 132 that are radially located within the cavities 120, 122 and 124 from centerpoints 134, 136 and 138, respectively. The radial ribs 132 provide additional strength to the inner core 108, 110 and 112 which prevents the inner core 108, 110 and 112 from flattening or collapsing under the weight of the watercraft. The radial ribs 132 can also be utilized on the roller 10 and the roller constructed from the two halves 60.

Although the present invention has been described with reference to preferred embodiments, workers skilled in the art will recognize that changes may be made in form and detail without departing from the spirit and scope of the invention.

What is claimed is:

1. A roller for mounting to a member of a conveying device or lifting device where the member has an axis, the roller comprising:
a rigid inner core having a first end and a second end comprising:
an outer wall having an outer surface and an inner surface; and
a plurality of spaced apart ribs extending from the inner surface wherein the plurality of ribs include bearing surfaces for engaging a circumference of the member; and
an outer layer attached to the outer surface of the rigid inner core wherein the outer layer includes a compressible material wherein the roller does not flatten with use.

2. The roller of claim 1 and wherein the rigid inner core comprises:
a first half; and
a second half wherein the first half and the second half attach together to form the rigid inner core.

3. The roller of claim 1 and wherein the rigid inner core further comprises at least one longitudinal rib extending from the first end to the second end wherein the at least one longitudinal rib intersects the plurality of spaced apart ribs and aligns with the axis of the member.

4. The roller of claim 1 and wherein the outer surface of the outer wall comprises a plurality of spaced apart channels.

5. The roller of claim 1 and wherein the inner rigid core further comprises a plurality of reinforcing ribs extending from the inner surface wherein the plurality of ribs wherein the reinforcing ribs radially extend from at least one centerpoint in an interior of the inner rigid core.

6. The roller of claim 1 and wherein the outer layer comprises a substantially uniform thickness about the outer surface of the rigid inner core.

7. The roller of claim 1 and wherein the outer layer has a thickness in the range of about 0.03 inches and about 0.3 inches.

8. The roller of claim 1 and wherein the outer layer is constructed from Poly(Styrene-Ethylene-Butadiene-Styrene) Elastomer, Thermoplastic Polyurethene, Thermoplastic Polyolefin or Thermoplastic Elastomer or a mixture thereof.

9. A roller for mounting to a member of a conveying device or lifting device where the member has an axis, the roller comprising:
a rigid inner core comprising an arcuate outer surface, a first end and a second end and a through bore for positioning about the member wherein the through bore extends from the first end to the second end; and
an outer layer attached to the outer surface of the rigid inner core wherein the outer layer includes a compressible material wherein the roller does not flatten with use.

10. The roller of claim 9 and wherein the rigid inner core comprises:
a first half; and
a second half wherein the first half and the second half attach together to form the rigid inner core.

11. The roller of claim 9 and wherein the rigid inner core further comprises:
an outer wall having the arcuate outer surface and an inner surface; and
a plurality of spaced apart ribs extending from the inner surface wherein the plurality of ribs include bearing surfaces for engaging a circumference of the member wherein the bearing surfaces define the through bore.

12. The roller of claim 11 and wherein the rigid inner core further comprises at least one longitudinal rib extending from the first end to the second end wherein the at least one longitudinal rib intersects the plurality of spaced apart ribs and aligns with the axis of the member.

13. The roller of claim 11 and wherein the inner rigid core further comprises a plurality of reinforcing ribs extending from the inner surface wherein the plurality of ribs wherein the reinforcing ribs radially extend from at least one centerpoint in an interior of the inner rigid core.

14. The roller of claim 9 and wherein the outer surface of the rigid inner core comprises a plurality of spaced apart channels.

15. The roller of claim 9 and wherein the outer layer comprises a substantially uniform thickness about the arcuate outer surface of the rigid inner core.

16. The roller of claim 9 and wherein the outer layer has a thickness in the range of about 0.03 inches and about 0.3 inches.

17. The roller of claim 9 and wherein the outer layer comprises SEBS Poly(Styrene-Ethylene-Butadiene-Styrene) Elastomer, Thermoplastic Polyurethene, Thermoplastic Polyolefin or Thermoplastic Elastomer or a mixture thereof.
